(19) United States
(12) Patent Application Publication
(10) Pub. No.: US 2015/0289172 A1
(43) Pub. Date: Oct. 8, 2015

(54) METHOD AND APPARATUS FOR TRANSMITTING DATA IN HETEROGENEOUS NETWORK

(71) Applicant: Electronics and Telecommunications Research Institute, Daejeon (KR)

(72) Inventors: Sung Woo CHOI, Daejeon (KR); IL GYU KIM, Chungcheongbuk-do (KR); Seung Chan BANG, Daejeon (KR)

(21) Appl. No.: 14/676,396

(22) Filed: Apr. 1, 2015

(30) Foreign Application Priority Data
Apr. 3, 2014 (KR) 10-2014-0040217

(51) Int. Cl. H04W 36/00; H04W 36/30; H04W 36/08

(52) U.S. Cl. CPC H04W 36/0055; H04W 36/08; H04W 36/30; H04W 36/0083

(57) ABSTRACT

For a transmitting terminal which is connected to a small base station of a small cell to transmit data to a receiving terminal belonging to another small cell, information of the receiving terminal to a target small base station to which the receiving terminal is connected is received from a small base station; when handover to the target small base station may be made, the handover to the target small base station is made depending on a handover instruction from the small base station and then data are transmitted to the receiving terminal through the target small base station.

### CROSS-REFERENCE TO RELATED APPLICATION

This application claims priority to and the benefit of Korean Patent Application No. 10-2014-0040217 filed in the Korean Intellectual Property Office on Apr. 3, 2014, the entire contents of which are incorporated herein by reference.

### BACKGROUND OF THE INVENTION

(a) Field of the Invention

The present invention relates to a method and an apparatus for transmitting data in a heterogeneous network, and more particularly, to a method for transmitting data between terminals belonging to a small cell.

(b) Description of the Related Art

At present, wireless data traffic has been increased day by day. To solve the increasing wireless traffic, wireless communication networks of several layers, not a single network, have been propagated. Many researches to solve mutual data transmission and interference in a multi-layer network, that is, a heterogeneous network, have been progressed.

The heterogeneous network is a network which is operated, having various kinds of cells having different coverage mixed therein. A small cell network having small coverage may show high-efficiency performance and may be operated at low costs since a distance between the respective terminals is very short.

A pico cell, a femto cell, a wireless relay, and the like, belong to a small cell and the small cell includes a small base station which manages the small cell. The small base station has unique cell coverage. The pico cell and the femto cell are connected to a backbone network in a wired line via the small base station. On the other hand, the wireless relay is wirelessly connected to a macro base station. A communication connection between the wireless relay and the macro base station is called a backhaul link and a connection between the terminal and a relay node is called an access link.

When several kinds of small cells are present in the macro cell, each small cell serves as a base station for terminals which will be managed by each small cell. For example, each small cell manages an uplink/downlink based on scheduling.

In the heterogeneous network environment, the configuration environment of the cell is fluid. The wireless relay may move and when the wireless relay moves, the cell regions may overlap and one terminal may be included in several cell regions.

However, even though the cell regions overlap, the terminals receiving services are connected to one cell. Changing the cells in which the terminals receive the services is handover and in the heterogeneous network environment, the terminals may perform the handover between the small cell and the macro cell and the handover between the small cells.

The terminals belonging to the wireless relay are connected to the backbone network via an access link and a backhaul link and the terminals belonging to the femto cell or the pico cell are connected to the backbone network via the small base station. The terminals belonging to different wireless relays inside the same macro cell may be connected via the macro base station, without passing through the backbone network.

Consider communication between the terminals belonging to different small cells inside the macro cell. The communication between terminals in different small cells may be made via the base station/backbone network and the direct communication between the terminals may be made.

Describing the case in which the communication between the terminals is made via the macro base station/backbone network, a process of transmitting data between the terminal connected to the small cell and the terminal of another small cell inside the macro cell is not simplified. The transmitting terminal transmits data to the small base station belonging thereto and the small base station transmits data the macro base station (wireless) or the backbone network (wired lined). The macro base station or the backbone network transmits data to the small base station of the small cell corresponding to a destination and the small base station transmits data to a receiving terminal. The transmission process is made via the macro base station or the backbone network and therefore generates an additional load for simple one-to-one transmission between the terminals. Four hops are generated based on the data. Further, considering a retransmission function, a processing delay, and the like for an error control in each transmission, a considerable delay may occur.

Unlike this, when the direct communication between the terminals is possible, the direct data may be transmitted. However, the direction communication process between the terminals requires a new protocol in a transmission and therefore is hardly applied in the heterogeneous network which is being considered. Therefore, the transmission through the direct communication between the terminals may be not made in the terminal which implements only the access link.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for transmitting data in a heterogeneous network having advantages of easily transmitting data between terminals connected to different small cells.

An exemplary embodiment of the present invention provides a method for transmitting, by a transmitting terminal connected to a small base station of a small cell, data to a receiving terminal belonging to another small cell. The method includes: transmitting information of the receiving terminal to the small base station; receiving a handover instruction to a target small base station to which the receiving terminal is connected from the small base station; handing over to the target small base station; and transmitting the data to the receiving terminal through the target small base station.

The receiving of the handover instruction may include reporting signal strength of adjacent cells to the small base station and the handover to the target small base station may be determined by the small base station based on the signal strength of the adjacent cells.

The receiving of the handover instruction may further include: receiving the handover instruction from the small base station when signal strength of the target small base station from the signal strength of the adjacent cells is equal to or more than a set threshold value.

The method may further include: receiving the handover instruction from the target small base station to the small base station after the transmission of the data is completed; and handing over to the small base station.

Another embodiment of the present invention provides a method for transmitting, by a small base station of a small cell to which a transmitting terminal is connected, data to a receiving terminal belonging to another small cell. The method includes: receiving information of the receiving terminal from the transmitting terminal; determining whether the transmitting terminal hands over to a target small base station searched based on the information of the receiving terminal; and instructing the handover to the transmitting terminal when the transmitting terminal hands over to the target small base station, wherein the data are transmitted to the receiving terminal through the target small base station.

The determining may include: receiving signal strength of adjacent cells from the transmitting terminal; and instructing the handover to the transmitting terminal when the signal strength of the target small base station from the signal strength of the adjacent cells is equal to or more than a set threshold value.

The method may further include: when the transmission of the data is completed, resetting a connection with the transmitting terminal.

Another embodiment of the present invention provides an apparatus for transmitting, by a small base station of a small cell to which a transmitting terminal is connected, data to a receiving terminal belonging to another small cell. The apparatus may include a receiver, a handover determiner, and a transmitter. The receiver may receive the information of the receiving terminal from the transmitting terminal. The handover determiner may determine whether the transmitting terminal hands over to a target small base station searched based on the information of the receiving terminal and if it is determined that the transmitting terminal hands over to the target small base station, determine the handover. The transmitter may transmit a handover instruction to the transmitting terminal. The data may be transmitted to the receiving terminal through the target small base station.

The receiver may receive signal strength of adjacent cells from the transmitting terminal and the handover determiner may determine the handover when the signal strength of the target small base station from the signal strength of the adjacent cells is equal to or more than a set threshold value.

Yet another embodiment of the present invention provides an apparatus for transmitting data from a transmitting terminal connected to a small base station of a small cell to a receiving terminal belonging to another small cell. The apparatus may include a handover performance unit and a transmitter. The handover performance unit may confirm whether handover from the small base station to a target small base station to which the receiving terminal is connected and if it is determined that the handover is made, handover to the target small base station. The transmitter may transmit the data to the receiving terminal through the target small base station.

The transmitter may transmit the information of the receiving terminal and signal strength of adjacent cells to the small base station and the small base station may search the target small base station based on the information of the receiving terminal and the small base station may determine whether the terminal hands over the target small base station based on the receiving strength of the adjacent cells.

### BRIEF DESCRIPTION OF THE DRAWINGS

FIGS. 1 and 2 are diagrams illustrating an example of a heterogeneous network according to an exemplary embodiment of the present invention.

FIG. 3 is a diagram illustrating a general example of a method for transmitting data between terminals connected to different small cells.

FIG. 4 is a diagram illustrating a method for transmitting data between terminals connected to different small cells in the heterogeneous network according to the exemplary embodiment of the present invention.

FIG. 5 is a diagram illustrating a method for transmitting data between terminals connected to different small cells in a heterogeneous network according to another exemplary embodiment of the present invention.

FIG. 6 is a diagram illustrating a method for transmitting data in a small base station according to an exemplary embodiment of the present invention.

FIG. 7 is a diagram illustrating an apparatus for transmitting data in a terminal according to an exemplary embodiment of the present invention.

FIG. 8 is a diagram illustrating an apparatus for transmitting data in a small base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Hereinafter, a method and an apparatus for transmitting data in a heterogeneous network according to an exemplary embodiment of the present invention will be described in detail with the accompanying drawings.

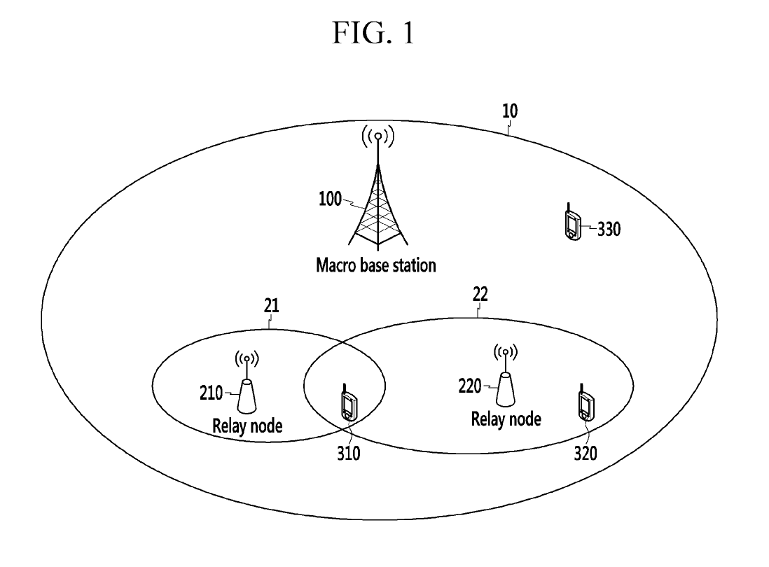

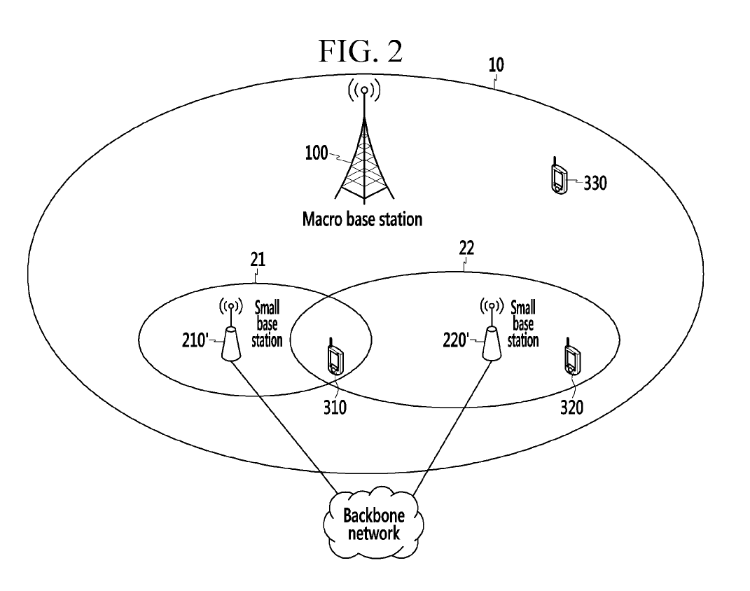

FIGS. 1 and 2 are diagrams illustrating an example of a heterogeneous network according to an exemplary embodiment of the present invention.

Referring to FIG. 1, a heterogeneous network includes a plurality of small cells 21 and 22 in one macro cell 10.

The macro cell 10 has a wide cell coverage, for example, a coverage of about 1 km and the small cells 21 and 22 have a coverage smaller than that of the macro cell 10. For example, the small cells 21 and 22 are a cell having a coverage of about 10 to 20 m and may be a pico cell, a femto cell, a relay node (relay), and the like. The small cells 21 and 22 are operated to provide a high-quality service to a terminal 300 in the corresponding area when a quality of service received by the terminal 300 from the macro cell 10 is poor.

The macro cell 10 includes a macro base station 100 which manages the macro cell 10. The macro base station 100 provides a service from a terminal 330 which is connected to the macro base station 100.

The small cells 21 and 22 each include the small base station which manages the small cells 21 and 22, respectively. As illustrated in FIG. 1, when the small cells 21 and 22 are formed by the relay node, the base station which manages the small cells 21 and 22 becomes relay nodes 210 and 220. The relay nodes 210 and 220 are wirelessly connected to the macro base station 100 through a backhaul link.

Meanwhile, as illustrated in FIG. 2, when the small cell 21 is a pico cell or a femto cell, small base stations 210′ and 220′ which mange the small cells 21 and 22 are connected to the backbone network by a wired line.

The relay nodes 210 and 220 or the small base stations 210′ and 220′ provide service to the terminals 310 and 320 which are each to connected thereto.

The terminals 310, 320, and 330 are connected to the macro base station 100 or the small base stations 210, 210′, 220, and 220′ to receive services.

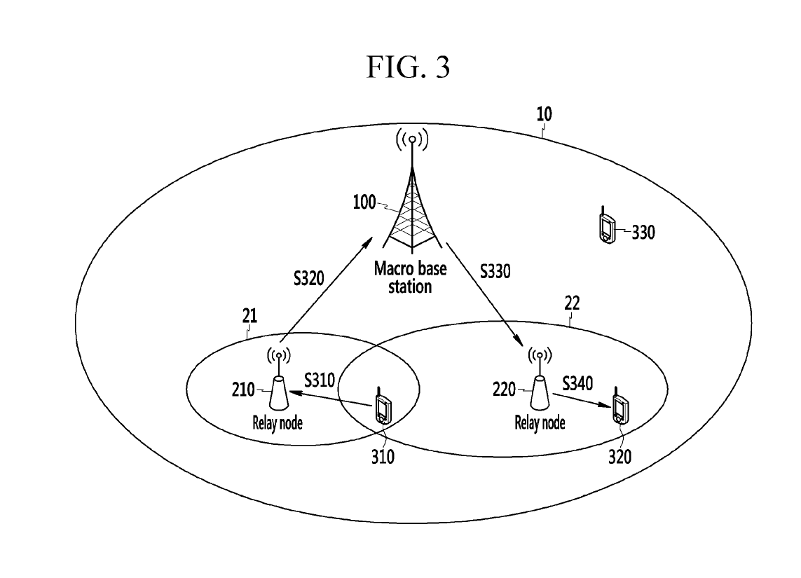

FIG. 3 is a diagram illustrating a general example of a method for transmitting data between terminals connected to different small cells.

Referring to FIG. 3, for the terminal 310 belonging to the small cell 21 to transmit data to the terminal 320 belonging to the small cell 22, the terminal 310 transmits data to the relay node 210 belonging thereto (S310) and the relay node 210 transmits data to the macro base station 100 (S320). The macro base station 100 transmits data to the relay node 220 (S330) and the relay node 220 transmits data to the terminal 320 (S340). As such, for the terminal 310 belonging to the small cell 21 to transmit data to the terminal 320 belonging to the small cell 22, four hops are generated based on data.

Further, in the heterogeneous network illustrated in FIG. 2, for the terminal 310 belonging to the small cell 21 to transmit data to the terminal belonging to the small cell 22, first, the terminal 310 transmits data to the small base station 210′ belonging thereto and the small base station 210′ transmits data the backbone network. The backbone network transmits data to the small base station 220′ and the small base station 220′ transmits data to the terminal 320. As such, for the terminal 310 belonging to the small cell 21 to transmit data to the terminal 320 belonging to the small cell 22, four hops are generated based on data.

Hereinafter, a method for allowing terminals 310 and 320 belonging to different small cells 21 and 22 in the heterogeneous network to easily transmit data will be described.

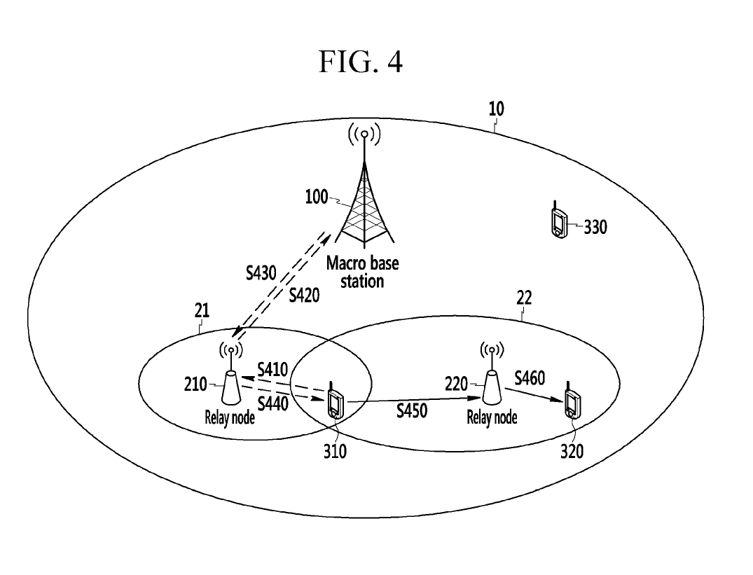

FIG. 4 is a diagram illustrating a method for transmitting data between terminals connected to different small cells in the heterogeneous network according to the exemplary embodiment of the present invention, in which as the heterogeneous network, the heterogeneous network illustrated in FIG. 1 is illustrated.

Referring to FIG. 4, to search for the position of the terminal 320 which is a destination of the data to be transmitted, the terminal 310 transmits search information to the relay node 210 (S410). The search information is information of the terminal 320 and is transferred to the macro base station 100 via the relay node 210 (S420).

The macro base station 100 searches for the terminal 320 based on the search information and informs the relay node 210 that the terminal 320 belongs to the small cell 22 (S430).

The relay node 210 determines whether the terminal 310 may handover to the small cell 22.

If it is determined that the terminal 310 may handover to the small cell 22, the relay node 210 instructs the terminal 310 to handover to the small cell 22 (S440).

The terminal 310 hands over to the small cell 22 depending on the handover instruction.

When the terminal 310 successfully hands over to the small cell 22, the terminal 310 is disconnected with the relay node 210 and is connected to the relay node 220.

The terminal 310 transmits data to the relay node 220 through an uplink (S450).

The relay node 220 stores data and then allocates downlink resources based on scheduling and transmits the received data to the terminal 320 through a downlink (S460).

The relay node 220 is set to be arbitrarily connected with the terminal 310 and therefore when the data transmission is completed, may instruct the terminal 310 to handover to the small cell 21 which is an original position.

Meanwhile, if it is determined that the terminal 310 may not handover to the small cell 22, the relay node 210 informs the terminal 310 that the terminal 310 may not handover to the small cell 22. Next, as the method described in FIG. 3, the terminal 310 transmits data to the relay node 210. The data transmitted to the relay node 210 are transmitted to the terminal 320 via the macro base station 100 and the relay node 220.

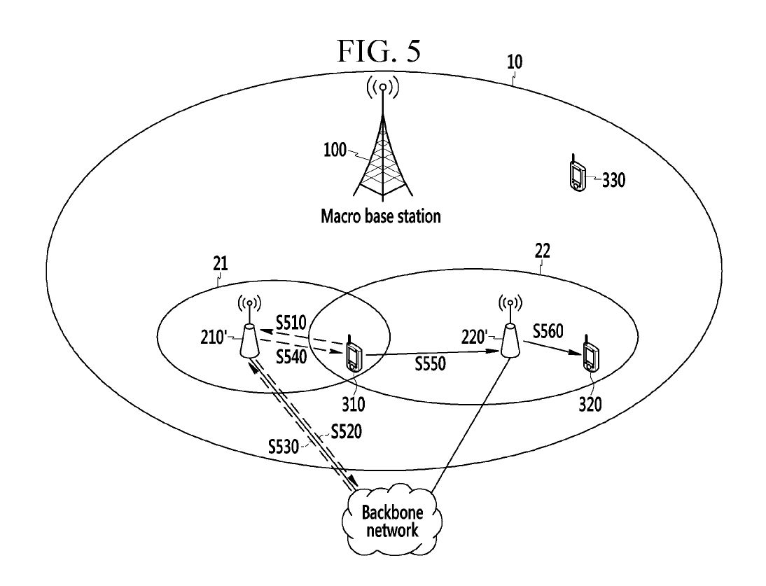

FIG. 5 is a diagram illustrating a method for transmitting data between terminals connected to different small cells in heterogeneous network according to another exemplary embodiment of the present invention, in which as the heterogeneous network, the heterogeneous network illustrated in FIG. 2 is illustrated.

Referring to FIG. 5, to search for the position of the terminal 320 which is a destination of the data to be transmitted, the terminal 310 transmits search information to the small base station 210′ (S510). The search information is transmitted to the backbone network via the small base station 210′ (S520).

The backbone network informs the small base station 210′ that the terminal 320 belongs to the small cell 22 (S530).

The small base station 210′ determines whether the terminal 310 may handover to the small cell 22.

If it is determined that the terminal 310 may handover to the small cell 22, the small base station 210′ instructs the terminal 310 to handover to the small cell 22 (S540).

The terminal 310 hands over to the small cell 22 depending on the handover instruction.

When the terminal 310 successfully hands over to the small cell 22, the terminal 310 is disconnected with the small base station 210′ and is connected to the small base station 220′.

The terminal 310 transmits data to the small base station 220′ through the uplink (S550).

The small base station 220′ stores data and then allocates downlink resources based on scheduling and transmits the data to the terminal 320 through the downlink (S560).

When the transmission of the data is completed, the terminal 310 may remain in the small cell 22 or return to the small cell 21. The terminal 310 again hands over to the small cell 21 so as to return to the small cell 21. The determination on whether the terminal 310 hands over to the small cell 21 is determined by the small base station 220′. When the small base station 220′ is set to be arbitrarily connected with the terminal 310 for data transmission, the small base station 220′ instructs the terminal 310 to immediately handover to the small cell 21 and when the small base station 220′ continuously supports the service to the terminal 310, the small base station 220′ maintains the connection with the terminal 310.

Meanwhile, if it is determined that the terminal 310 may not handover to the small cell 22, the small base station 210′ informs the terminal 310 that the terminal 310 may not handover to the small cell 22. Next, the terminal 310 transmits data to the small base station 210′. The data transmitted to the small base station 210′ are transmitted to the terminal 320 via the backbone network and the small base station 220′.

As such, the communication between the terminals in the same cell may more reduce the load of the entire network than the communication between terminals in other cells. For communication with another cell, as illustrated in FIG. 3, data needs to pass through the macro base station 100 or the backbone network and when the data belongs to the same cell, the data pass through only the corresponding base stations 220 (FIGS. 4) and 220′ (FIG. 5).

That is, generally, the handover is to change a cell on service for the terminal and maintain connectivity. Meanwhile, according to the exemplary embodiment of the present invention, when a target cell which is to be connected by the terminal 310 is generated, the terminal hands over to the target cell. In this case, the base station of the target cell registers the terminal 310 in the cell group member and thus the terminal in the cell group member may perform communication through only the corresponding base station.

Therefore, the terminal 310 transmits data to the corresponding base stations 220 (FIGS. 4) and 220′ (FIG. 5) through the uplink and the terminal 320 receives data through the downlink. Therefore, the terminal does not pass through the macro base station 100 or the backbone network and therefore the load of the entire network may be reduced.

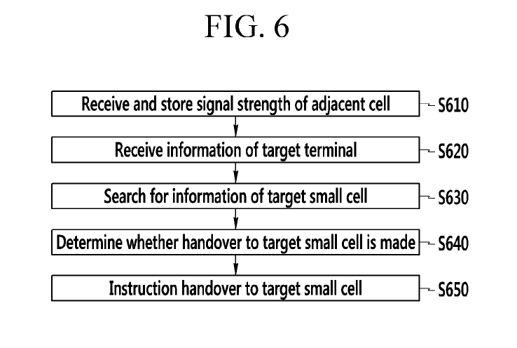

FIG. 6 is a diagram illustrating a method for transmitting data in a small base station according to an exemplary embodiment of the present invention. In FIG. 6, the small base station 210′ which is connected to the terminal 310 to transmit data will be described and the relay node 210 may also be operated identically therewith.

Referring to FIG. 6, the small base station 210′ has a new handover determination standard, unlike the existing handover method. The existing determination standard of handover is signal strength of adjacent cells and when the adjacent cells having signal strength larger than that of the serving cell are present, the handover is determined. Meanwhile, according to the exemplary embodiment of the present invention, the terminal 310 needs to be connected to the target small cell (for example, 22) and then handover to the target small cell 22 is determined by checking the signal strength of the target small cell 22. If it is determined from the signal strength of the target small cell 22 that the terminal 310 may be connected to the target small cell 22, the small base station 210′ may instruct the handover to the target small cell 22 till the purpose is achieved.

The small base station 210′ receives the signal strength of the adjacent cells from each terminal and stores the received signal strength of the adjacent cells (S610). To this end, the terminal connected to the small base station 210′ measures the signal strength of the adjacent cells and reports the measured signal strength to the small base station 210′ at any time. The signal strength of the adjacent cell may represent the strength of the signal transmitted from the base stations of the adjacent cells.

The small base station 210′ receives the information of the target terminal 320 which is the destination of the data from the terminal 310 (S620).

The small base station 210′ searches for the information of the target small cell to which the target terminal 320 belongs (S630). The small base station 210′ may transmit the information of the target terminal 320 to the backbone network and receive the information of the target small cell to which the target terminal 320 belongs from the backbone network.

The small base station 210′ determines whether the terminal 320 may handover to the target small cell using the signal strength of the adjacent cells (S640). To this end, the small base station 210′ checks whether the signal strength of the target small cell is larger than a threshold value. In this case, the threshold value may be set to be a minimum signal strength value which the terminal 310 may be connected to the target small cell.

When the signal strength of the target small cell is larger than the threshold value, the small base station 210′ is determined that the target small cell may be connected to the terminal 310 and instructs the terminal 310 to handover to the target small cell (S650).

The terminal 310 handovers to the target small cell 22 depending on the handover instruction to transmit data to the small base station 220′ of the target small cell 22. When the transmission of the data is completed, the terminal 310 may return to the original small cell 21 or maintain the connection in the target small cell 22. When the terminal 310 is temporarily connected for a predetermined purpose, the small base station 220′ of the target small cell 22 may instruct the terminal 310 to handover to the original small cell 21 so as to return to the original small cell 21.

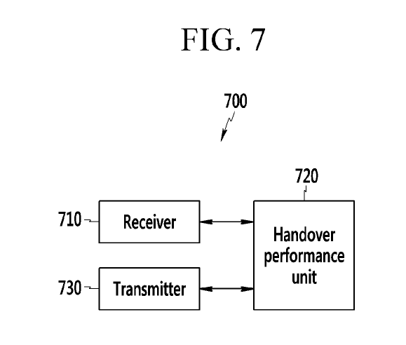

FIG. 7 is a diagram illustrating an apparatus for transmitting data in a terminal according to an exemplary embodiment of the present invention.

Referring to FIG. 7, an apparatus 700 for transmitting data includes a receiver 710, a handover performance unit 720, and a transmitter 730. The apparatus 700 for transmitting data may be included in the terminal 310.

The receiver 710 receives a handover instruction from the small base station 210 or 210′.

When receiving the handover instruction to the target small base station 220 or 220′ from the small base station 210 or 210′, the handover performance unit 720 hands over to the small base station 220 or 220′.

The transmitter 730 transmits the information of the target terminal 320, which is the destination of the data which will be transmitted, to the small base station 210 or 210′. Further, when the handover to the target small base station 220 or 220′ is completed, the transmitter 730 transmits data to the target small base station 220 or 220′.

As such, when the data to be transmitted are present in another small cell, the handover performance unit 720 confirms whether the handover to another small cell may be made from the small base station 210 or 210′ and then when the handover may be made, performs the handover to transmit data.

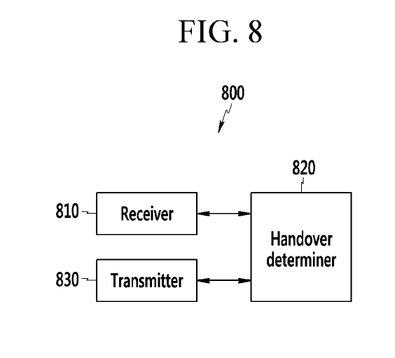

FIG. 8 is a diagram illustrating an apparatus for transmitting data in a small base station according to an exemplary embodiment of the present invention.

Referring to FIG. 8, an apparatus 800 for transmitting data includes a receiver 810, a handover determiner 820, and a transmitter 830. The apparatus 800 for transmitting data may be included in the base station of the small cells 21 and 22.

The receiver 810 receives the information of the target terminal 320 which is the destination of the data to be transmitted from the terminal 310. Further, the receiver 810 receives the information of the target small cell 22 to which the target terminal is connected from the backbone network or the macro base station.

The handover determiner 820 determines whether the terminal 310 may handover to the target small base station 220 or 220′ and if it is determined that the handover of the terminal 310 to the target small base station 220 or 220′ may be made, determines the handover and transmits the handover instruction through the transmitter 830.

At least some functions of the method and apparatus for transmitting data in the heterogeneous network according to the exemplary embodiment of the present invention as described above may be implemented by hardware or software coupled with the hardware. For example, processors, such as a central processing unit (CPU), other chipsets, and a microprocessor, may perform a function of the handover performance unit 720 or the handover determiner 820 and a transceiver may perform a function of the receiver 710 or 810 and the transmitter 730 or 830.

According to the exemplary embodiments of the present invention, it is possible to reduce the load which is generated in the macro base station or the backbone network at the time of performing the data communication between the terminals belonging to different small cells in the heterogeneous network. Thereby, it is possible to increase the transmission capacity of the heterogeneous network.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting, by a transmitting terminal which is connected to a small base station of a small cell, data to a receiving terminal belonging to another small cell, comprising:
transmitting information of the receiving terminal to the small base station;
receiving a handover instruction to a target small base station to which the receiving terminal is connected from the small base station;
handing over to the target small base station; and
transmitting the data to the receiving terminal through the target small base station.

2. The method of claim 1, wherein the receiving of the handover instruction includes reporting signal strength of adjacent cells to the small base station, and the handover to the target small base station is determined by the small base station based on the signal strength of the adjacent cells.

3. The method of claim 2, wherein the receiving of the handover instruction further includes receiving the handover instruction from the small base station when signal strength of the target small base station from the signal strength of the adjacent cells is equal to or more than a set threshold value.

4. The method of claim 1, further comprising:
receiving the handover instruction from the target small base station to the small base station after the transmission of the data is completed; and
handing over to the small base station.

5. A method for transmitting, by a small base station of a small cell to which a transmitting terminal is connected, data to a receiving terminal belonging to another small cell, comprising:
receiving information of the receiving terminal from the transmitting terminal;
determining whether the transmitting terminal hands over to a target small base station searched based on the information of the receiving terminal; and
instructing the handover to the transmitting terminal when the transmitting terminal hands over to the target small base station,
wherein the data are transmitted to the receiving terminal through the target small base station.

6. The method of claim 5, wherein the determining includes:
receiving signal strength of adjacent cells from the transmitting terminal; and
instructing the handover to the transmitting terminal when the signal strength of the target small base station from the signal strength of the adjacent cells is equal to or more than a set threshold value.

7. The method of claim 5, further comprising when the transmission of the data is completed, resetting a connection with the transmitting terminal.

8. An apparatus for transmitting, by a small base station of a small cell to which a transmitting terminal is connected, data to a receiving terminal belonging to another small cell, comprising:
a receiver receiving information of the receiving terminal from the transmitting terminal;
a handover determiner determining whether the transmitting terminal hands over to a target small base station searched based on the information of the receiving terminal and if it is determined that the transmitting terminal hands over to the target small base station, determining the handover; and
a transmitter transmitting a handover instruction to the transmitting terminal,
wherein the data are transmitted to the receiving terminal through the target small base station.

9. The apparatus of claim 8, wherein the receiver receives signal strength of adjacent cells from the transmitting terminal, and the handover determiner determines the handover when the signal strength of the target small base station from the signal strength of the adjacent cells is equal to or more than a set threshold value.

10. The apparatus of claim 8, wherein the handover determiner acquires information of the target small base station through a backbone network or a macro base station.

11. An apparatus for transmitting data from a transmitting terminal which is connected to a small base station in a small cell to a receiving terminal belonging to another small cell, comprising:
a handover performance unit confirming whether handover from the small base station to the a target small base station to which the receiving terminal is connected and if it is determined that the handover is made, handing over to the target small base station; and
a transmitter transmitting the data to the receiving terminal through the target small base station.

12. The apparatus of claim 11, wherein the transmitter transmits the information of the receiving terminal and signal strength of adjacent cells to the small base station, and the small base station searches the target small base station based on the information of the receiving terminal and the small base station determines whether the terminal hands over the target small base station based on the receiving strength of the adjacent cells.
